(19) United States
(12) Patent Application Publication
(10) Pub. No.: US 2026/0040197 A1
(43) Pub. Date: Feb. 5, 2026

(54) NETWORK SLICE SECURITY FOR NON 3GPP ACCESS

(71) Applicant: Nokia Technologies Oy, Espoo (FI)

(72) Inventors: Jing PING, Chengdu (CN); Saurabh KHARE, Bangalore (IN); Ranganathan MAVUREDDI DHANASEKARAN, Munich (DE)

(21) Appl. No.: 19/099,936

(22) PCT Filed: Aug. 14, 2022
(86) PCT No.: PCT/CN2022/112343

§ 371 Date: Jan. 30, 2025

(51) Int. Cl. H04W 48/16; H04W 12/037; H04W 12/08; H04W 48/18

(52) U.S. Cl. CPC H04W 48/16; H04W 12/037; H04W 12/08; H04W 48/18

(57) ABSTRACT

Various example embodiments relate to methods and apparatuses for network slice security for non-3GPP access. An apparatus may be configured to send to an access network device, a request message comprising network slice group information corresponding to network slice identification information of the terminal device; and receive from the access network device, an identification of a non-3GPP access network device capable of serving at least one network slice indicated in the network slice identification information in response to the request message.

### TECHNICAL FIELD

Various example embodiments described herein generally relate to communication technologies, and more particularly, to methods and apparatuses for network slice security for non 3GPP access.

### BACKGROUND

Certain abbreviations that may be found in the description and/or in the figures are herewith defined as follows:
AMF Access and Mobility Management Function
AN Access Network
AN NRF Access Network Network Repository Function
AP Access Point
CN Core Network
MITM Man-in-the-Middle
NAS Non-Access Stratum
NSSAI Network Slice Selection Assistance Information
NSASG Network Slice Access Stratum Group
N3IWF Non-3GPP Interworking Function
NRF Network Repository Function
OAM Operation Administration and Maintenance
SBA Service Based Architecture
S-NSSAI Single Network Slice Selection Assistance Information
TNAP Trusted Non-3GPP Access Point
TNGF Trusted Non-3GPP Gateway Function
UDM Unified Data Management
UE User Equipment

Third Generation partnership project, 3GPP, provides an architecture allowing a user equipment (UE) to connect to a core network using not only a 3GPP radio access network but also a non-3GPP access network. For example, access network gateways such as a non-3GPP interworking function (N3IWF), a trusted non-3GPP gateway function (TNGF), and the like, may be configured to enable access to the core network. Security protection of the UE is desired so as to protect the privacy of the user.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device is provided. The terminal device may comprise at least one processor and at least one memory. The at least one memory may store instructions that, when executed by the at least one processor, may cause the terminal device at least to send to an access network device, a request message comprising network slice group information corresponding to network slice identification information of the terminal device; and receive from the access network device, an identification of a non-3GPP access network device capable of serving at least one network slice indicated in the network slice identification information in response to the request message.

In a second aspect, an example embodiment of an access network device is provided. The access network device may comprise at least one processor and at least one memory. The at least one memory may store instructions that, when executed by the at least one processor, may cause the access network device at least to receive from a terminal device, a request message comprising network slice group information corresponding to network slice identification information of the 2 terminal device; and send to the terminal device, an identification of a non-3GPP access network device capable of serving at least one network slice indicated in the network slice identification information in response to the request message.

In a third aspect, an example embodiment of a core network device is provided. The core network device may comprise at least one processor and at least one memory. The at least one memory may store instructions that, when executed by the at least one processor, may cause the core network device at least to determine network slice group information corresponding to network slice identification information of a terminal device; and send configuration information indicative of a mapping between network slice group information and network slice identification information to an access network device in a non-3GPP access network configured to provide access for the terminal device.

Example embodiments of methods, apparatus and computer program products are also provided. Such example embodiments generally correspond to the example embodiments in the above aspects and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIGS. 1A and 1B illustrates examples communication networks in which example embodiments of the present disclosure can be implemented.

FIG. 2 is a high level message flow diagram illustrating a process for discovery of a non-3GPP access network device according to an example embodiment of the present disclosure.

FIG. 3 is a schematic message flow diagram illustrating a process for discovery of a non-3GPP access network device according to an example embodiment of the present disclosure.

FIG. 4 is a schematic table illustrating mapping configuration related to a network slice according to an example embodiment of the present disclosure.

FIG. 5 is a schematic message flow diagram illustrating a process for discovery of a non-3GPP access network device according to an example embodiment of the present disclosure.

FIG. 6 is a schematic message flow diagram illustrating a process for discovery of a non-3GPP access network device according to an example embodiment of the present disclosure.

FIG. 7 is a schematic message flow diagram illustrating a process for discovery of a non-3GPP access network device according to an example embodiment of the present disclosure.

FIG. 8 is a schematic flowchart illustrating operations for discovery of a non-3GPP access network device implemented at a terminal device according to an example embodiment of the present disclosure.

FIG. 9 is a schematic flowchart illustrating operations for discovery of a non-3GPP access network device implemented at an access network device according to an example embodiment of the present disclosure.

FIG. 10 is a schematic flowchart illustrating operations for discovery of a non-3GPP access network device implemented at a core network device according to an example embodiment of the present disclosure.

FIG. 11 is a schematic structure block diagram illustrating devices in a communication system in which example embodiments of the present disclosure can be implemented.

FIG. 12 is a schematic functional block diagram illustrating an apparatus according to an example embodiment of the present disclosure.

FIG. 13 is a schematic functional block diagram illustrating an apparatus according to an example embodiment of the present disclosure.

FIG. 14 is a schematic functional block diagram illustrating an apparatus according to an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “terminal device” or “user equipment” (UE) refers to any entities or devices that can communicate with the access network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

As used herein, the term “access network device” refers to any suitable entities or devices that can provide a wireless or wired communication function for the terminal device. For the non-3GPP access, the access network device may be an access point such as a trusted non-3GPP access point (TNAP), a network node such as a non-3GPP interworking function (N3IWF), or a trusted non-3GPP gateway function (TNGF), or any other entities that may facilitate the terminal device to access the core network.

As used herein, the term “network function” (NF) refers to a processing function in a network, and defines a functional behavior and an interface. The network function may be implemented by using dedicated hardware, or may be implemented by running software on dedicated hardware, or may be implemented on a form of a virtual function on a common hardware platform. From a perspective of implementation, network functions may be classified into a physical network function and a virtual network function. From a perspective of use, network functions may be classified into a dedicated network function and a shared network function.

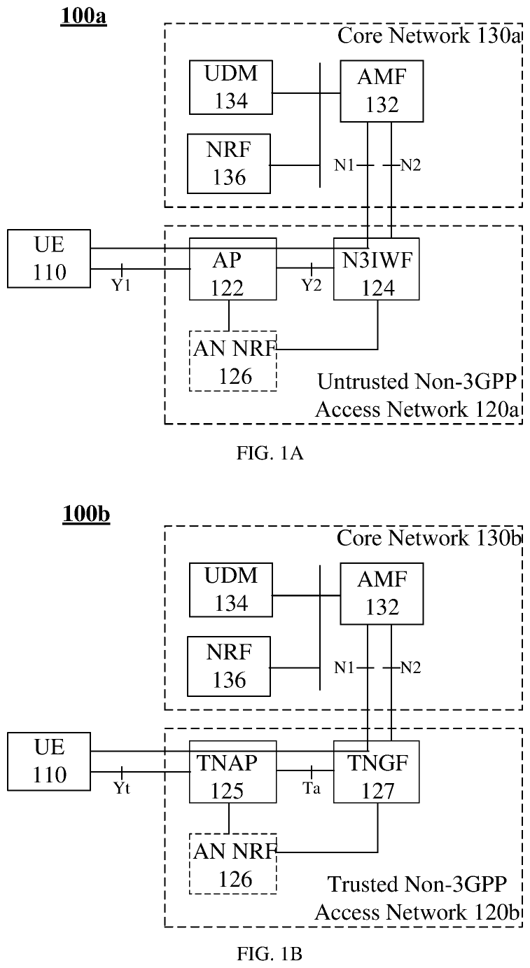

FIGS. 1A and 1B illustrate examples communication networks in which example embodiments of the present disclosure can be implemented. Referring to FIG. 1A first, the UE 110 may access the core network 130a (e.g., 5GC) by using the non-3GPP access technology, e.g., a WiFi access or a fixed network access. The core network 130a defines a service based architecture (SBA) based on the concept of network slicing and virtualized network functions (NF). In the example of FIG. 1A, the UE 110 may access the access and mobility management function (AMF) 132 in the core network 130a via an untrusted non-3GPP access network 120a, which may include an access point (AP) 122 and a non-3GPP interworking function (N3IWF) 124. The N3IWF 124 may relay, via the N1 interface, non-access stratum (NAS) signaling between the UE 110 and the AMF 132 to enable the UE to have a direct NAS signaling connection towards the AMF 132. Although the N3IWF 124 is shown as being located within the untrusted non-3GPP access network 120a, in other embodiments the N3IWF 124 may be located outside the non-3GPP access network 120a, e.g., within the core network 130a.

FIG. 1A shows additional network functions, e.g., unified data management (UDM) 134, and network repository function (NRF) 136, which may be coupled to the AMF 132. The UDM 134 may be configured to store subscription information of the UE 110. The NRF 136 may be configured to discover and provide candidate NF or NF service information, e.g., information about an NF instance, slice information of the NF instance. Although not shown, other network functions such as session management function (SMF), authentication server function (AUSF), network slice selection function (NSSF), policy control function (PCF) may also be included in the core network 130a. Further, FIG. 1A shows additional interfaces for various network elements to communicate with one another. An interface between the UE 110 and the AP 122 is a Y1 interface, an interface between the AP 122 and the N3IWF 124 is a Y2 interface, and an interface between the N3IWF 124 and the AMF 132 is an N2 interface.

To enable the UE 110 to select an access network node (e.g., N3IWF) that supports the slice information requested by the UE 110, an access network network repository function (AN NRF) 126 may be deployed in the access network 120a. The AN NRF 126 may function similar to the NRF 136 in the core network 130a. For example, the UE 110 may perform an N3IWF discovery procedure to the AN NRF 126 by reusing NF discover service operation as defined in TS 23.502. Further, one or more N3IWFs may register a set of slices, e.g., single network slice selection assistance information (S-NSSAIs) they support by reusing NF register service operation as defined in TS 23.502 or any similar service operation supported in the communication network. For the sake of security, the AN NRF 126 may be a different NF hosted by a different platform than the NRF 136 in the core network 130a.

FIG. 1B illustrates a trusted non-3GPP access network (TNAN) 120b, through which the UE 110 may access the AMF 132 in the core network 130b. The TNAN 120b may include a trusted non-3GPP access point (TNAP) 125 and a trusted non-3GPP gateway function (TNGF) 127. The TNGF 127 may relay, via the N1 interface, non-access stratum (NAS) signaling between the UE 110 and the AMF 132 to enable the UE to have a direct NAS signaling connection towards the AMF 132. FIG. 1B shows additional interfaces for various network elements to communicate with one another. An interface between the UE 110 and the TNAP 125 is a Yt interface, an interface between the TNAP 125 and the TNGF 127 is a Ta interface, and an interface between the TNGF 127 and the AMF 132 is an N2 interface.

To enable the UE 110 to select an access network node (e.g., TNAP) that supports the slice information requested by the UE 110, an AN NRF 126 may be deployed in the access network 120b similar to FIG. 1A. For example, the UE 110 may perform an NF discovery procedure to the AN NRF 126 by reusing NF discover service operation. Further, one or more TNAPs may register a set of slices (e.g., S-NSSAIs) they support by reusing NF register service operation or any similar service operation supported in the communication network.

With the network architecture shown in FIGS. 1A and 1B, the UE 110 may be able to discover the network slice (which may also be briefly referred to as slice) of the access network device (e.g., N3IWF, TNGF) and select the access network device accordingly. However, exposing the slice information (e.g., S-NSSAI) of the UE 110 or network devices to other UEs will cause privacy issues. For example, the UE 110 may provide requested slice information without any protection. In this case, a Man-in-the-Middle (MITM) may be able to check what slices or services the UE 110 is interested in. This would pose risks from a security point of view, and needs to be addressed in order to prevent leaking of privacy information of the user.

Therefore, it is desirable to provide an efficient mechanism to support discovery of an access network device (e.g., in a non-3GPP access network) to be used for a UE to access the core network with reduced or no privacy concerns.

Hereinafter, example embodiments of methods and apparatuses supporting discovery of a non-3GPP access network device would be described in detail with reference to the drawings. In the example embodiments, slice group information instead of the slice information itself may be used for the discovery procedure. The example embodiments allow a UE to discover and select the access network device without slice information exposure. Thus, the security performance can be improved. Though some example embodiments are described in the context of a 5G system, it would be appreciated that various example embodiments described herein can also be applicable to a 4G LTE system, or a beyond 5G system.

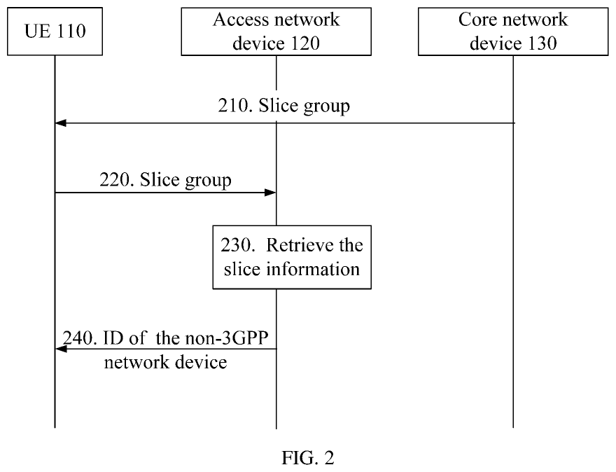

FIG. 2 is a high level message flow diagram illustrating a process for discovery of a non-3GPP access network device according to an example embodiment. The operations shown in FIG. 2 may be performed by a user equipment, one or more access network devices, and a core network device. For example, the UE 110, an access network device 120 (e.g., the N3IWF 124, TNAP 125, or AN NRF 126) in the access network 120a or 120b, and a core network device 130 (e.g., the AMF 132) in the core network 130a or 130b described above with reference to FIGS. 1A and 1B may be configured to perform the discovery procedure. The UE 110, the access network device 120 and the core network device 130 each may include a plurality of components, modules, means or elements to perform operations discussed below, and the components, modules, means and elements may be implemented in various manners including but not limited to for example software, hardware, firmware or any combination thereof to perform the operations.

Referring to FIG. 2, the network slice identification information (e.g., S-NSSAI list) of the UE 110's subscription may be stored in the unified data management (e.g., UDM 134). The core network device 130 may then use the subscription information of the UE 110 stored in the UDM 134. In an example, based on the subscribed slice information of the UE 110, the core network device 130 may determine network slice group information corresponding to the network slice identification information. For example, the core network device 130 may create a list of slice group (e.g., Network Slice Access Stratum Groups (NSASGs)) based on preset configuration information. At an operation 210, the core network device 130 may send the network slice group information to the UE 110 via a NAS message in a subscription procedure as defined in TS 23.501 and TS 23.502, for example.

At an operation 220, the UE 110 may send a request message to the access network device 120, e.g., when the UE 110 wants to discover a gateway relevant to the UE request services or slices. Instead of sending the network slice identification information, the UE 110 may include the network slice group information in the request message. For example, the UE 110 may send the NSASGs list that corresponds to the requested S-NSSAIs of the UE 110. Since the slice identification is not exposed in the request message, privacy concerns may be avoided.

Upon receiving the request message from the UE 110, at an operation 230, the access network device 120 may retrieve the slice identification information requested by the UE 110. For example, the access network device 120 may be configured with the configuration information indicative of the mapping between the network slice group information and the network slice identification information by the core network device 130, or an Operation Administration and Maintenance (OAM) server. Based on such configuration information, the access network device 120 is able to derive the network slice identification information requested by the UE 110.

Further, the access network device 120 may determine at least one non-3GPP access network device (e.g., a gateway or access point) that is capable of serving the network slice indicated in the network slice identification information, based on the received slice group information or the retrieved slice identification information. For example, in a case where the access network device 120 is an AN NRF, the access network device 120 may determine one or more N3IWFs or TNAPs that may match the requirements of the network slices indicated in the S-NSSAIs. In case where the access network device 120 is an N3IWF or TNAP, the access network device 120 may determine the set of NSASGs or corresponding S-NSSAIs it may support.

Then, at an operation 240, the core network device 130 may send a response message to the UE 110 to indicate at least one non-3GPP access network device that may be capable of serving at least one network slice indicated in the network slice indication information. For example, the response message may include an identification of one or more N3IWFs or TNAPs that can serve or support the network slices requested by the UE 110, so that the UE 110 may select the corresponding N3IWF or TNAP to attach to the core network.

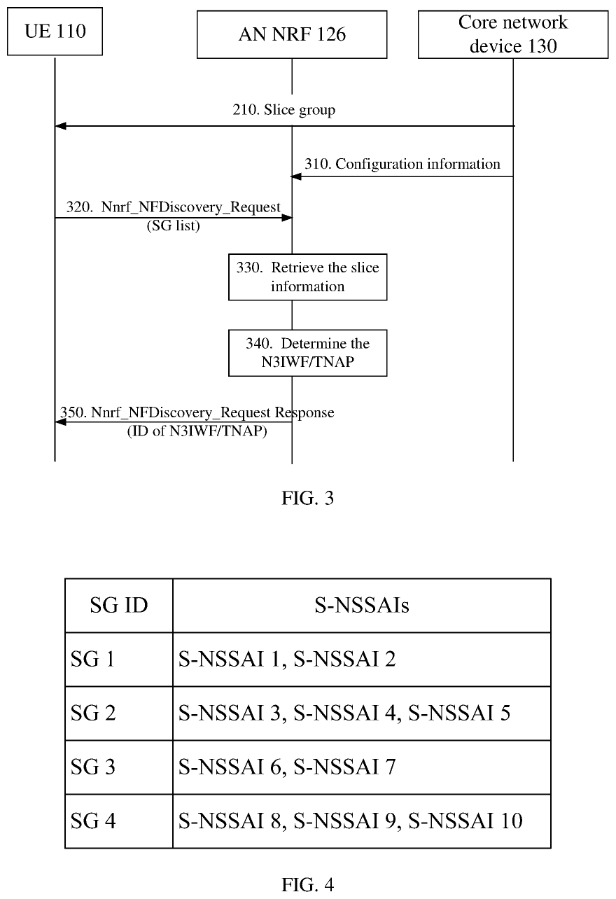

FIG. 3 is a schematic message flow diagram illustrating a process for discovery of a non-3GPP access network device according to an example embodiment. The process shown in FIG. 3 may be performed by for example the UE 110, the AN NRF 126 of the access network, and the core network device 130. It would be appreciated that the operations shown in FIG. 3 represent a specific example of the procedure discussed above with reference to FIG. 2 and can be incorporated into the procedure shown in FIG. 2.

Referring to FIG. 3, at an operation 210, the core network device 130 may send network slice group information to the UE 110, e.g., via a NAS message. The network slice group information may include a slice group (SG) list that corresponds to the subscribed S-NSSAIs of the UE 110. In an example, the SG list may be generated in accordance with a mapping configuration between a slice group identification and one or more corresponding network slices.

FIG. 4 is a schematic table illustrating mapping configuration related to a network slice according to an example embodiment. Referring to FIG. 4, a plurality of S-NSSAIs may be classified or clustered into several slice groups (SGs). That is, one slice group may correspond to one or more network slices. In an example, the S-NSSAIs may be organized based on various factors, such as the function, tenant, or region of the respective S-NSSAI, or the like. As shown in FIG. 4, S-NSSAI 1, S-NSSAI 2 are grouped into SG 1, S-NSSAI 3 through S-NSSAI 5 are grouped into SG 2, S-NSSAI 6, S-NSSAI 7 are grouped into SG 3, and S-NSSAI 8 through S-NSSAI 10 are grouped into SG 4. Although FIG. 4 shows that one S-NSSAI is mapped to a single slice group, it would be understood that this is merely an example and not limiting. For example, two different SGs may share one or more S-NSSAIs in some occasions.

Based on the mapping configuration, the core network device 130 may create slice groups e.g. network slice access stratum groups (NSASGs) that correspond to the subscribed S-NSSAIs of the UE 110. For example, if the UE 110 subscribes to S-NSSAI 3, S-NSSAI 4 and S-NSSAI 7, then the core network device 130 may determine corresponding SG identification information i.e. SG2, SG3, and send such information to the UE 110 via a NAS message.

Turning back to FIG. 3, to facilitate the AN NRF 126 to retrieve the slice information of the UE 110. At an operation 310, the core network device 130 may send the configuration information to the AN NRF 126. As described above with reference to FIG. 4, the configuration information may indicate a mapping between the network slice group information and the network slice identification information.

In an example embodiment, the core network device 130 may configure the configuration information for the AN NRF 126 via a core network procedure. For example, the AMF 132 may configure or update the list of mapping between the SGs and S-NSSAIs via the SBA interface. Alternatively or additionally, the OAM may configure the list of mapping in the AN NRF 126.

Although FIG. 3 shows that the configuration information is configured by the core network device 130, it shall be noted that this is merely an example and not limiting. For example, one or more N3IWFs or TNGFs may register to the AN NRF 126 with mapping between the SGs and S-NSSAIs supported by the respective N3IWF or TNGF. For example, the N3IWF or TNGF may send a profile including the set of supported S-NSSAIs and corresponding SGs to the AN NRF 126, e.g., by using an NF Register service operation.

At an operation 320, the UE 110 may send an NF discovery request to the AN NRF 126, when the UE 110 wants to access the core network service through the non-3GPP access network. In an example, the UE 110 may send an Nnrf_NFDiscovery_Request to the AN NRF 126. The request message may include the slice group list information received from the core network device 130. Since the slice identification information is not exposed in the request message, the security performance can be improved.

In response to receiving the request message, at an operation 330, the AN NRF 126 may retrieve the slice identification information corresponding to the received slice group information. For example, based on the mapping configuration received from the core network device 130, the AN NRF 126 may determine one or more S-NSSAIs corresponding to the received SG list.

Then, at an operation 340, the AN NRF 126 may determine one or more access network devices (e.g., N3IWF or TNAP) that can serve or support the list of target S-NSSAIs. For example, an N3IWF or TNAP that can match the requirements indicated in the S-NSSAIs may be determined to a candidate access network device to be used for the UE 110 to attach to the core network.

In an example embodiment, the AN NRF 126 may take into account both the list of S-NSSAI and the Internet protocol (IP) address of the UE 110 (e.g., source address of the request message in operation 320) to determine a best matching N3IWF or TNAP that can serve the list of target S-NSSAI requested by the UE 110 and whose IP address is close to the IP address of the UE 110.

At an operation 350, the AN NRF 126 may send a response to the UE 110 to indicate the determined access network device. In an example, the AN NRF 126 may send an Nnrf_NFDiscovery_Request Response to the UE 110. The response message may include an identification of the determined N3IWF or TNAP, e.g., public IP address of the N3IWF or TNAP. Based on such information, the UE 110 may then select an N3IWF or TNAP to access the core network.

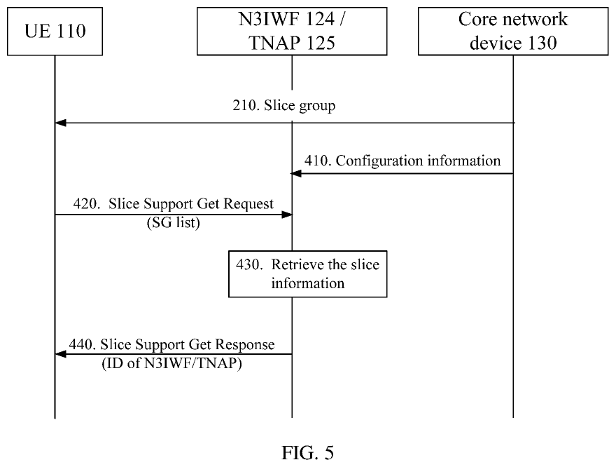

FIG. 5 is a schematic message flow diagram illustrating a process for discovery of a non-3GPP access network device according to an example embodiment. The process shown in FIG. 5 may be performed by for example the UE 110, the N3IWF 124 or TNAP 125 of the access network, and the core network device 130. It would be appreciated that the operations shown in FIG. 5 represent a specific example of the procedure discussed above with reference to FIG. 2 and can be incorporated into the procedure shown in FIG. 2.

Referring to FIG. 5, at an operation 210, the core network device 130 may send network slice group information to the UE 110, e.g., via a NAS message. The network slice group information may include a slice group (SG) list that corresponds to the subscribed S-NSSAIs of the UE 110. In an example, the SG list may be generated in accordance with a mapping configuration between a slice group identification and one or more corresponding network slices. The details of the mapping configuration may be substantially the same as the description made with reference to the FIGS. 3 and 4, and a redundant description thereof is omitted here.

At an operation 410, the core network device 130 may send the configuration information to the N3IWF 124 or TNAP 125. In an example, the core network device 130 may configure a list of SGs corresponding to the S-NSSAIs supported by the N3IWF 124 or TNGF 125. For example, the AMF 132 may configure or update the list of SGs via the SBA interface. Alternatively or additionally, the OAM may configure the list of SGs in the N3IWF 124 or TNAP 125.

At an operation 420, the UE 110 may send a request message to the N3IWF 124 or TNAP 125. For example, when the UE 110 has selected a set of candidate N3IWFs or TNAPs including the N3IWF 124 or TNAP 125, the UE 110 may send a Slice Support Get request to each of these N3IWFs or TNAPs. The request message may include the slice group list information received from the core network device 130. Since the slice identification information is not exposed in the request message, the security performance can be improved.

At an operation 430, the N3IWF 124 or TNAP 125 may retrieve the slice identification information corresponding to the received slice group information. For example, based on the mapping configuration received from the core network device 130, the N3IWF 124 or TNAP 125 may determine one or more SGs and corresponding S-NSSAIs that they may support.

Then, at an operation 440, the N3IWF 124 or TNAP 125 may send a response message to the UE 110 to indicate which slice(s) the N3IWF 124 or TNAP 125 may support. In an example, the AN NRF 126 may send a Slice Support Get Response to the UE 110. Similar to operation 420, the response message may include an SG list the N3IWF 124 or TNAP 125 may support rather than the S-NSSAIs, thus the slice information is exchanged under protection.

After all the candidate N3IWFs or TNAPs have been queried, based on the identification (e.g., IP address of the N3IWF 124 or TNAP 125) indicated in the response message, the UE 110 may be aware of which candidate N3IWF/TNAP can serve or support which S-NSSAIs the UE 110 wish to use. Then, the UE 110 may take into account the set of slices it wishes to use and the slices supported by the candidate N3IWF/TNAP as indicated in the response message to select an N3IWF or TNAP that can best support the slices the UE 110 wishes to use.

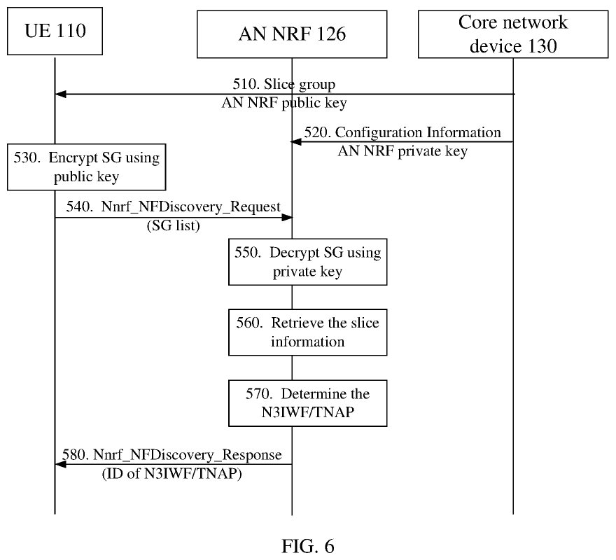

FIG. 6 is a schematic message flow diagram illustrating a process for discovery of a non-3GPP access network device according to an example embodiment. The process shown in FIG. 6 may be performed by for example the UE 110, the AN NRF 126 of the access network, and the core network device 130.

As discussed above, the slice group list may be organized based on the function, tenant or region, etc. of the network slices. For example, referring to FIG. 4, the SG1, SG2, SG3, SG4 may refer to social media function, multimedia function, finance-related function, and video streaming function, respectively. In this case, the “plain text” slice group information in the discovery request sent by the UE 110 may disclose the behavior of a user, leading to a risk of privacy information leakage. A malicious user (e.g., MITM) may figure out the behavior of the user of UE 110 even based on slice group information if the malicious user can get the mapping between SGs and S-NSSAIs for subscribed slices.

To ensure security of the slice group information to be sent by the UE 110, the core network device 130 or OAM may generate a pair of a public key and a private key associated with the AN NRF 126. At an operation 510, the core network device 130 may send to the UE 110 the network slice group information, as well as the public key. Further, at an operation 520, the core network device 130 may send to the AN NRF 126 the configuration information, as well as the private key. It would be understood that the network slice group information and the public key may be sent via different messages, and the configuration information and the private key may also be sent via different messages.

In a case where a discovery procedure is desired, the UE 110 may, at an operation 530, encrypt the network slice group information using the public key. Then, at an operation 540, the UE 110 may send a request message to the AN NRF 126, such as Nnrf_NFDiscovery_Request. The request may include the encrypted slice group list. Other aspects of the request message may be substantially the same as the description made with reference to the FIG. 3, and a redundant description thereof is omitted here.

Upon receiving the discovery request, the AN NRF 126 may first, at an operation 550, decrypt the encrypted network slice group information by using the private key to obtain the decrypted slice group list. Then at an operation 560, the AN NRF 126 may retrieve the network slice identification information corresponding to the decrypted slice group list information, based on the configuration information. Taking into account the network slice identification information, as well as other information such as the IP address of the UE 110, at an operation 570, the AN NRF 126 may determine one or more candidate N3IWFs or TNAPs that can server or support the network slice(s) requested by the UE 110. Then, at an operation 580, the AN NRF 126 may send the identification of the candidate N3IWFs or TNAPs to the UE 110, e.g., via an NFDiscovery response message. The operations 560, 570, 580 are analogous to operations 330, 340, 350 described above and a reductant description is omitted here.

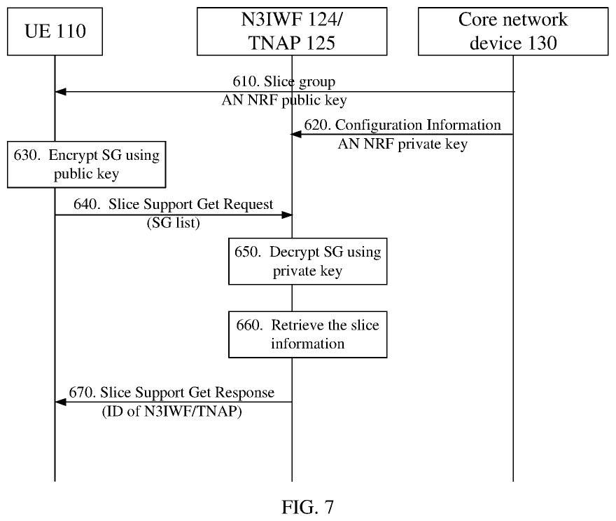

FIG. 7 is a schematic message flow diagram illustrating a process for discovery of a non-3GPP access network device according to an example embodiment. The process shown in FIG. 7 may be performed by for example the UE 110, the N3IWF 124 or TNAP 125 of the access network, and the core network device 130.

Similar to the process illustrated in FIG. 6, to ensure security of slice group information to be sent by the UE 110, the core network device 130 or OAM may generate a pair of a public key and a private key associated with the N3IWF 124 or TNAP 125. At an operation 610, the core network device 130 may send to the UE 110 the network slice group information, as well as the public key. Further, at an operation 620, the core network device 130 may send to the N3IWF 124 or TNAP 125 the configuration information, as well as the private key. It would be understood that the network slice group information and the public key may be sent via different messages, and the configuration information and the private key may also be sent via different messages.

In a case where a discovery procedure is desired, the UE 110 may, at an operation 630, encrypt the network slice group information using the public key. Then, at an operation 640, the UE 110 may select one or more candidate N3IWFs or TNAPs, and send a request message to each of these N3IWFs or TNAPs, e.g., the N3IWF 124 or TNAP 125. The request message may include the encrypted slice group list. Other aspects of the request message may be substantially the same as the description made with reference to the FIG. 5, and a redundant description thereof is omitted here.

Upon receiving the discovery request, the N3IWF 124 or TNAP 125 may first, at an operation 650, decrypt the encrypted network slice group information by using the private key to obtain the decrypted slice group list. Then at an operation 660, the N3IWF 124 or TNAP 125 may retrieve the network slice identification information corresponding to the network slice group information, and determine a set of slice groups (e.g., NSASGs) and corresponding slices (e.g., S-NSSAIs) that the N3IWF 124 or TNAP 125 may support, based on the configuration information. Then, at an operation 670, the N3IWF 124 or TNAP 125 may send to the UE 110 a response message that may contain the set of slice groups.

After all the candidate N3IWFs or TNAPs have been queried, based on the identification of the N3IWFs or TNAPs indicated in the response message, the UE 110 may be aware of which N3IWF or TNAP supports which set of network slices. Based on such information, the UE 110 may select an N3IWF or TNAP that may best support the set of slices the UE wishes to use. Other aspects of the operations 670, 670 are analogous to operations 430, 440 described above and a reductant description is omitted here.

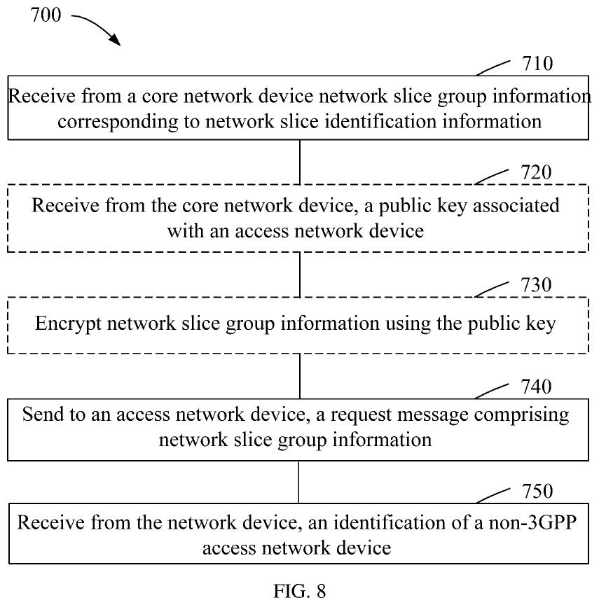

FIG. 8 shows a flowchart of an example method 700 for discovery of a non-3GPP access network device according to an example embodiment of the present disclosure. The method 700 can be implemented at a terminal device e.g. the UE 110 discussed above. It would be understood that step illustrated in dashed-line block represent an optional step and can be omitted in some example embodiments. In some example embodiments, the method 700 may further include one or more steps that are performed at the UE 110 as described above with respect to FIGS. 2-7. It would also be understood that details of some steps in the procedure 700 have been discussed above with respect to FIGS. 2-7 and the procedure 700 will be described here in a simple manner.

At block 710, the terminal device may receive from a core network device, network slice group information corresponding to network slice identification information of the terminal device.

At block 720, the terminal device may receive from a core network device, a public key associated with the access network device.

At block 730, the terminal device may encrypt the network slice group information using the public key.

At block 740, the terminal device may send to an access network device, a request message comprising the network slice group information corresponding to network slice identification information of the terminal device.

At block 750, the terminal device may receive from the access network device, an identification of a non-3GPP access network device capable of serving at least one network slice indicated in the network slice identification information in response to the request message.

In some example embodiments, the identification of the non-3GPP access network device is an address of the non-3GPP access network device.

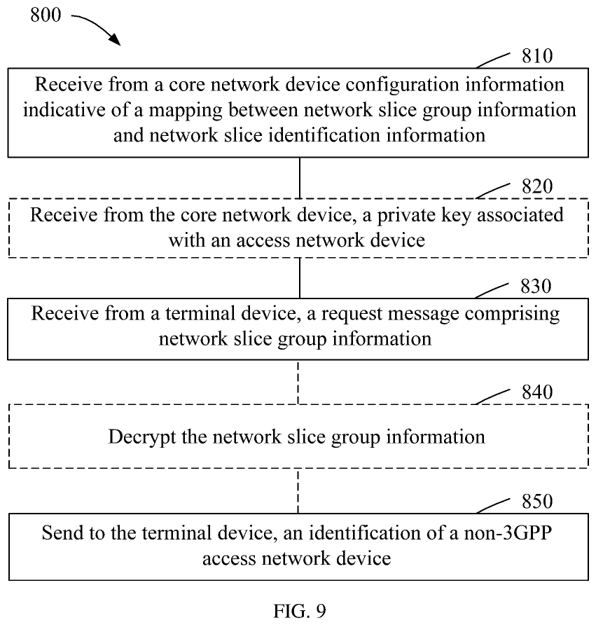

FIG. 9 shows a flowchart of an example method 800 for discovery of a non-3GPP access network device according to an example embodiment of the present disclosure. The method 800 can be implemented at an access network device, e.g., the N3IWF 124, TNAP 125, or AN NRF 126 discussed above. It would be understood that step illustrated in dashed-line blocks represent an optional step and can be omitted in some example embodiments. In some example embodiments, the method 800 may further include one or more steps that are performed at the N3IWF 124, TNAP 125, or AN NRF 126 as described above with respect to FIGS. 2-7. It would also be understood that details of some steps in the procedure 800 have been discussed above with respect to FIGS. 2-7 and the procedure 800 will be described here in a simple manner.

At block 810, the access network device may receive from a core network device, configuration information indicative of a mapping between network slice group information and network slice identification information.

At block 820, the access network device may receive from the core network device, a private key associated with the access network device.

At block 830, the access network device may receive from a terminal device, a request message comprising network slice group information corresponding to network slice identification information of the terminal device.

At block 840, the access network device may decrypt the network slice group information using the private key.

At block 850, the access network device may retrieve the network slice identification information corresponding to the network slice group information, based on the configuration information.

At block 860, the access network device may send to the terminal device, an identification of a non-3GPP access network device capable of serving at least one network slice indicated in the network slice identification information in response to the request message.

In some example embodiments, the identification of the non-3GPP network node is determined based at least on the network slice identification information and an identification of the terminal device. For example, the identification of the terminal device is an IP address of the terminal device indicated in the request message.

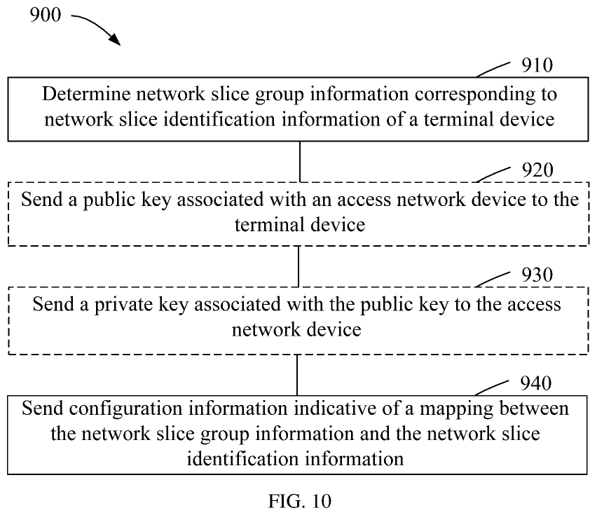

FIG. 10 shows a flowchart of an example method 900 for discovery of a non-3GPP access network device in accordance with an example embodiment of the present disclosure. The method 900 can be implemented at a core network device, e.g. the AMF 132 discussed above. In some example embodiments, the method 900 may further include one or more steps that are performed at the core network device 130 as described above with respect to FIGS. 2-7. It would also be understood that details of some steps in the procedure 900 have been discussed above with respect to FIGS. 2-7 and the procedure 900 will be described here in a simple manner.

At block 910, the core network device may determine network slice group information corresponding to network slice identification information of a terminal device.

At block 920, the core network device may send a public key associated with the access network device to the terminal device.

At block 930, the core network device may send a private key associated with the public key to the access network device.

At block 940, the core network device may send configuration information indicative of a mapping between network slice group information and network slice identification information to an access network device in a non-3GPP access network configured to provide access for the terminal device.

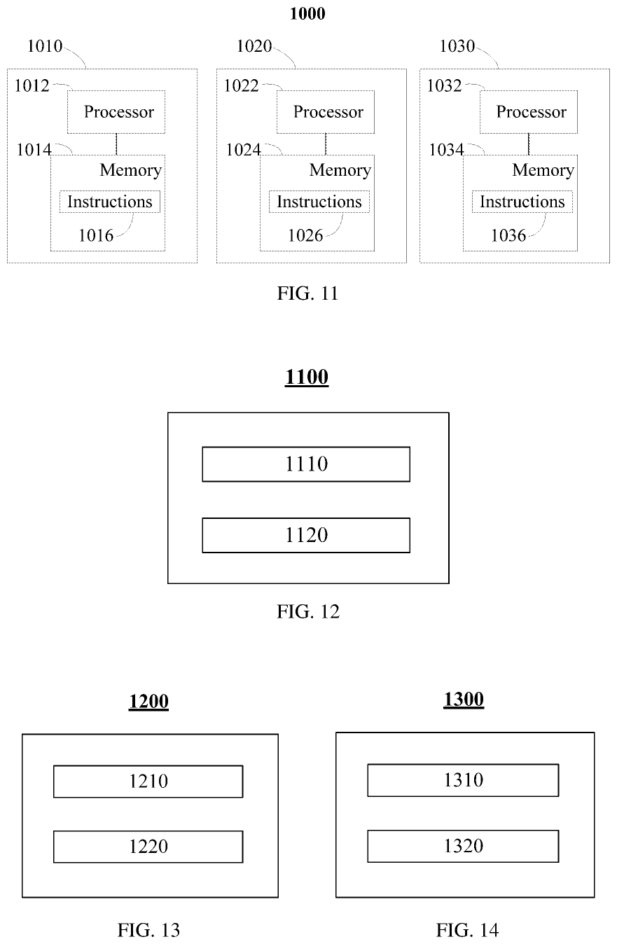

FIG. 11 is a schematic structure block diagram illustrating devices in a communication system 1000 in which example embodiments of the present disclosure can be implemented. As shown in FIG. 11, the communication system 1000 may comprise a terminal device 1010 which may be implemented as the UE 110 discussed above, an access network device 1020 which may be implemented as the N3IWF 124, TNAP 125, or AN NRF 126 discussed above, and a core network device 1030 which may be implemented as the AMF 132 discussed above.

Referring to FIG. 11, the terminal device 1010 may comprise one or more processors 1012, and one or more memories 1014 interconnected through one or more buses. The one or more buses may be address, data, or control buses, and may include any interconnection mechanism such as series of lines on a motherboard or integrated circuit, fiber, optics or other optical communication equipment, and the like. The one or more memories 1014 may include program instruction 1016. The one or more memories 1014 and the program instruction 1016 may be configured to, when executed by the one or more processors 1012, cause the terminal device 1010 to perform processes and steps relating to the UE 110 as described above. Further, in various example embodiments, the example device 1010 may also include one or more transceivers. Each of the one or more transceivers may comprise a receiver and a transmitter, which are connected to one or more antennas. The terminal device 1010 may wirelessly communicate with the access network device 1020 through the one or more antennas.

The access network device 1020 may comprise one or more processors 1022, and one or more memories 1024 interconnected through one or more buses. The one or more buses may be address, data, or control buses, and may include any interconnection mechanism such as a series of lines on a motherboard or integrated circuit, fiber, optics or other optical communication equipment, and the like. Further, in various example embodiments, the example device 1020 may also include one or more network interfaces. The one or more network interfaces may provide wired or wireless communication links through which the access network device 1020 may communicate with other network devices, entities, elements or functions. The one or more memories 1024 may include program instruction 1026. The one or more memories 1024 and the program instruction 1026 may be configured to, when executed by the one or more processors 1022, cause the access network device 1020 to perform processes and steps relating to the N3IWF 124, TNAP 125, or AN NRF 126 as described above.

The core network device 1030 may comprise one or more processors 1032, and one or more memories 1034 interconnected through one or more buses. The one or more buses may be address, data, or control buses, and may include any interconnection mechanism such as a series of lines on a motherboard or integrated circuit, fiber, optics or other optical communication equipment, and the like. Further, in various example embodiments, the example device 1030 may also include one or more network interfaces. The one or more network interfaces may provide wired or wireless communication links through which the core network device 1030 may communicate with other network devices, entities, elements or functions. For example, the core network device 1030 may communicate with the terminal device 1010 over the N1 interface and communicate with the access network device 1020 via N2 interface. The one or more memories 1034 may include program instruction 1036. The one or more memories 1034 and the program instruction 1036 may be configured to, when executed by the one or more processors 1032, cause the core network device 1030 to perform processes and steps relating to the AMF 132 as described above.

The one or more processors 1012, 1022 and 1032 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 1012, 1022 and 1032 may be configured to control other elements of the network device/network node and operate in cooperation with them to implement the procedures discussed above.

The one or more memories 1014, 1024 and 1034 may include at least one storage medium in various forms, such as a transitory memory and/or a non-transitory memory. The transitory memory may include, but not limited to, for example, a random access memory (RAM) or a cache. The non-transitory memory may include, but not limited to, for example, a read only memory (ROM), a hard disk, a flash memory, and the like. The term “non-transitory,” as used herein, is a limitation of the medium itself (i.e., tangible, not a signal) as opposed to a limitation on data storage persistency (e.g., RAM vs. ROM). Further, the one or more memories 1014, 1024 and 1034 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

FIG. 12 is a schematic functional block diagram illustrating an apparatus 1100 according to an example embodiment of the present disclosure. The apparatus 1100 may be implemented at a terminal device like the UE 110 to perform operations relating to the UE 110 as discussed above. Since the operations relating to the UE 110 have been discussed in detail with reference to FIGS. 2-7, the blocks of the apparatus 1100 will be described briefly here and details thereof may refer to the above description.

Referring to FIG. 12, the apparatus 1100 may include a first means 1110 for sending to an access network device, a request message comprising network slice group information corresponding to network slice identification information of the terminal device, and a second means 1120 for receiving from the access network device, an identification of a non-3GPP access network device capable of serving at least one network slice indicated in the network slice identification information in response to the request message.

In some example embodiments, the apparatus 1100 may further include a third means for receiving from a core network device, the network slice group information corresponding to the network slice identification information of the terminal device.

In some example embodiments, the apparatus 1100 may further include a fourth means for receiving from a core network device, a public key associated with the access network device; and encrypting the network slice group information using the public key.

In some example embodiments, the identification of the non-3GPP access network device is an address of the non-3GPP access network device.

FIG. 13 is a schematic functional block diagram illustrating an apparatus 1200 according to an example embodiment of the present disclosure. The apparatus 1200 may be implemented at an access network node like N3IWF 124, TNAP 125, or AN NRF 126 to perform operations relating to these nodes as discussed above. Since the operations relating to the N3IWF 124, TNAP 125, or AN NRF 126 have been discussed in detail with reference to FIGS. 2-7, the blocks of the apparatus 1200 will be described briefly here and details thereof may refer to the above description.

Referring to FIG. 13, the apparatus 1200 may include a first means 1210 for receiving from a terminal device, a request message comprising network slice group information corresponding to network slice identification information of the terminal device; and a second means 1220 for sending to the terminal device, an identification of a non-3GPP access network device capable of serving at least one network slice indicated in the network slice identification information in response to the request message.

In some example embodiments, the apparatus 1200 may further include a third means for receiving from a core network device, configuration information indicative of a mapping between network slice group information and network slice identification information.

In some example embodiments, the apparatus 1200 may further include a fourth means for retrieving the network slice identification information corresponding to the network slice group information of the terminal device, based on the configuration information.

In some example embodiments, the identification of the non-3GPP network node is determined based at least on the network slice identification information and an identification of the terminal device.

In some example embodiments, the identification of the terminal device is an IP address of the terminal device indicated in the request message.

In some example embodiments, the apparatus 1200 may further include a fifth means for receiving from a core network device, a private key associated with the access network device; and decrypting the network slice group information using the private key.

FIG. 14 is a schematic functional block diagram illustrating an apparatus 1300 according to an example embodiment of the present disclosure. The apparatus 1300 may be implemented at a network function like the core network device 130 to perform operations relating to the core network device 130 as discussed above. Since the operations relating to the core network device 130 have been discussed in detail with reference to FIGS. 2-7, the blocks of the apparatus 1300 will be described briefly here and details thereof may refer to the above description.

Referring to FIG. 14, the apparatus 1300 may include a first means 1310 for determining network slice group information corresponding to network slice identification information of a terminal device; and a second means 1320 for sending configuration information indicative of a mapping between network slice group information and network slice identification information to an access network device in a non-3GPP access network configured to provide access for the terminal device.

In some example embodiments, the apparatus 1300 may further include a third means for sending a public key associated with the access network device to the terminal device; and sending a private key associated with the public key to the access network device.

Some exemplary embodiments further provide program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium.

A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A terminal device, comprising:
at least one processor; and
at least one memory storing instructions that, when executed by the at least one processor, cause the terminal device at least to:
send to an access network device, a request message comprising network slice group information corresponding to network slice identification information of the terminal device; and
receive from the access network device, an identification of a non-3GPP access network device capable of serving at least one network slice indicated in the network slice identification information in response to the request message.

2. The terminal device of claim 1, wherein the at least one memory further stores instructions that, when executed by the at least one processor, cause the terminal device at least to:
receive from a core network device, the network slice group information corresponding to the network slice identification information of the terminal device.

3. The terminal device of claim 1, wherein the at least one memory further stores instructions that, when executed by the at least one processor, cause the terminal device at least to:
receive from a core network device, a public key associated with the access network device; and
encrypt the network slice group information using the public key.

4. The terminal device of any preceding claim 1, wherein the identification of the non-3GPP access network device is an address of the non-3GPP access network device.

5. An access network device, comprising:
at least one processor; and
at least one memory storing instructions that, when executed by the at least one processor, cause the access network device at least to:
receive from a terminal device, a request message comprising network slice group information corresponding to network slice identification information of the terminal device; and
send to the terminal device, an identification of a non-3GPP access network device capable of serving at least one network slice indicated in the network slice identification information in response to the request message.

6. The access network device of claim 5, wherein the at least one memory further stores instructions that, when executed by the at least one processor, cause the access network device at least to:
receive from a core network device, configuration information indicative of a mapping between network slice group information and network slice identification information.

7. The access network device of claim 6, wherein the at least one memory further stores instructions that, when executed by the at least one processor, cause the access network device at least to:
retrieve the network slice identification information corresponding to the network slice group information of the terminal device, based on the configuration information.

8. The access network device of claim 5, wherein the identification of the non-3GPP network node is determined based at least on the network slice identification information and an identification of the terminal device.

9. The access network device of claim 8, wherein the identification of the terminal device is an IP address of the terminal device indicated in the request message.

10. The access network device of claim 5, wherein the at least one memory further stores instructions that, when executed by the at least one processor, cause the access network device at least to:
receive from a core network device, a private key associated with the access network device; and
decrypt the network slice group information using the private key.

11. A core network device, comprising:
at least one processor; and
at least one memory storing instructions that, when executed by the at least one processor, cause the core network device at least to:
determine network slice group information corresponding to network slice identification information of a terminal device; and
send configuration information indicative of a mapping between network slice group information and network slice identification information to an access network device in a non-3GPP access network configured to provide access for the terminal device.

12. The core network device of claim 11, wherein the at least one memory further stores instructions that, when executed by the at least one processor, cause the core network device at least to:
send a public key associated with the access network device to the terminal device; and
send a private key associated with the public key to the access network device.

13-31. (canceled)
